(19) United States
(12) Patent Application Publication
(10) Pub. No.: US 2004/0072567 A1
(43) Pub. Date: Apr. 15, 2004

(54) Method of selecting cells of base stations for soft-handover connection, and a network for mobile telecommunications

(76) Inventors: Qiang Cao, Swindon (GB); Patrick Georges Vencestas Charriere, Tetbury (GB); Seau Sian Lim, Swindon (GB); Philip Charles Sapiano, Corsham (GB)

Correspondence Address: Docket Administrator (Room 3J-219), Lucent Technologies Inc., 101 Crawfords Corner Road, Holmdel, NJ, 07733-3030, US

(21) Appl. No.: 10/659,510

(22) Filed: Sep. 10, 2003

(30) Foreign Application Priority Data
Oct. 15, 2002 (EP) 02257151.7

(51) Int. Cl. H04Q 7/20; H04B 7/00

(52) U.S. Cl. 455/442; 455/436; 455/450; 455/509

(57) ABSTRACT

A method is provided of selecting cells (18,22) of base stations (16,24) of a network for mobile telecommunications for soft-handover connection with a mobile user terminal (20) so as to provide at a first network node (14) multiple received representations of a data frame from the mobile user terminal (20) within a predetermined period. For each cell (18,22) delay due to transfer of a representation of the received data frame across interface(s) (28,30,8) between network nodes along a transfer path to said first network node (14) is estimated by determining the contribution to the delay caused by each interface along the transfer path. Cells (18,22) are selected dependent upon the associated delays.

### CROSS REFERENCE TO RELATED APPLICATION

This application claims priority of European Application No. 02257151.7 filed on Oct. 15, 2002.

### TECHNICAL FIELD

The present invention relates to telecommunications, and more particularly, wireless communications.

### BACKGROUND OF THE INVENTION

In code division multiple access (CDMA) systems, a mobile user terminal may be in a region in which soft-handover is possible. In a soft-handover scenario, signals from the mobile user terminal are received by more than one cell of a network.

In a soft-handover scenario, a mobile user terminal is normally given a set of neighbouring cells (known as a “monitor set”) to monitor and report on the radio quality of each cell in the monitor set. Whenever a cell becomes a candidate for a soft-handover connection, the mobile user terminal (user equipment, UE) reports the radio quality of that cell to the network. The network then decides (based on the report) whether to make the cell part of the active set to each of which such a soft-handover connection is established.

The selection criteria for choosing whether a cell should be in soft-handover connection (i.e., part of the active set) depends on the radio conditions (such as Common Pilot Channel quality) and radio resources (such as channelization code, cell load). In a real system, other than radio-related resources and conditions, there are practical constraints such the loading (i.e., amount of traffic) being handled by an interface and bandwidth limits.

When there is more than one soft-handover connection, the best quality received signal from amongst those received is selected. Selecting the best signal of these received by the different cells (in the uplink direction), and from the different cells (in the downlink direction) is however only possible where the delay between signals via different cells is not too large. In a Universal Mobile Telecommunications System (UMTS) system, differences in loading of the cells and bandwidth limitations can result in different delays, reducing the possibility of always being able to select the best signal received via different cells.

### SUMMARY OF THE INVENTION

The present invention provides a method of selecting cells of base stations of a network for mobile telecommunications for soft-handover connection with a mobile user terminal so as to provide at a first network node multiple received representations of a data frame from the mobile user terminal within a predetermined period, for each cell delay due to transfer of a representation of the received data frame across interface(s) between network nodes along a transfer path to said first network node is estimated by determining the contribution to the delay caused by each interface along the transfer path, cells being selected dependent upon the associated delays.

The method of selecting cells is for inclusion in an active set of cells in soft-handover connection.

The method of selecting cells is for inclusion in a set of cells to be monitored as to radio quality for possible inclusion in an active set of cells in soft-handover connection.

Cells may be selected dependent on factors comprising the delay estimated, the received signal quality and the radio resources available.

Each cell estimated as providing a representation of the received data frame that arrives at said first network node later than a predetermined time after the first of the representations of the received data frame is not selected.

Furthermore the first network node is a radio network controller (RNC).

The present invention may also provide a network for mobile telecommunications comprising a selector operative to select cells of base stations for soft-handover connection with a mobile user terminal so as to provide at a first network node multiple received representations of a data frame from the mobile user terminal within a predetermined period, and further comprising delay estimation means operative to estimate, for each cell, delay due to transfer of a representation of the received data frame across interface(s) between network nodes along a transfer path to said first network node by determining the contribution to the delay caused by each interface along the transfer path, the selector being operative to select cells dependent upon the associated delays.

The selector is operative to select cells for inclusion in an active set of cells in soft-handover connection.

The selector (12) is operative to select cells for inclusion in a set of cells to be monitored as to radio quality for possible inclusion in an active set of cells in soft-handover connection.

The selector (12) is operative to select cells dependent on factors comprising the delay estimated, the received signal quality and the radio resources available.

The selector (12) is operative such that each cell (18,22) providing a representation of the received data frame that arrives at said first network node (14) later than a predetermined time (W) after the first (F) of the representations of the received data frame is not selected.

Furthermore the first network node (14) is a radio network controller (RNC), and the network comprises at least one further radio network controller (26), at least one radio network controller to radio network controller interface (8) and at least two radio network controller to base station interfaces (28,30).

Furthermore said first network node (14) comprises the selector (12).

Selection of cells of base stations for soft-handover (also known as soft handoff) based on delay differences between a serving radio network controller (SRNC) and base stations (Node B).

In various embodiments, the criteria for selecting a cell to be used or monitored for soft-handover including consideration of received signal quality and radio resource usage (e.g. cell loading) are extended to include delay differences caused by interface(s) between the serving radio network controller (RNC) and the base stations. The difference in delay of the interface between Serving RNC and Node B is directly related to the difference in traffic load in the interfaces.

By considering the delay differences of the interfaces, various embodiments have the following advantages. Firstly, selection of the best received signal is possible. Secondly, unnecessary messaging is avoided from radio network controller to mobile user terminal and radio network controller to base station to establish soft-handover connections of no benefit In other words, unnecessary signalling in establishing transport bearers that may not be usable in soft-handover is avoided. Thirdly, the size of the buffer required to; store delayed traffic at the serving radio network controller is reduced. In other words, less buffering in the radio network controller (RNC) is required to store some frames whilst waiting for other frames from all of which to select. Fourthly, unnecessary reporting is avoided from the mobile user terminal regarding a cell in a monitor set with good radio quality but high delay on the associated interface(s).

Various embodiments provide a selection approach based not only on radio quality and resource criteria but also on physical interface constraints for including or excluding a cell from the active set or monitored set for soft-handover connection.

### BRIEF DESCRIPTION OF THE DRAWINGS

The present invention will be better understood from reading the following description of non-limiting embodiments, with reference to the attached drawings, wherein below:

FIG. 1 is a diagram illustrating a UMTS telecommunications network, and

FIG. 2 is a diagram illustrating, an example of uplink message timing.

It should be emphasized that the drawings of the instant application are not to scale but are merely representations and thus are not intended to portray the specific parameters or the structural details of the invention, which may be determined by one of skill in the art by examination of the information contained herein.

### DETAILED DESCRIPTION

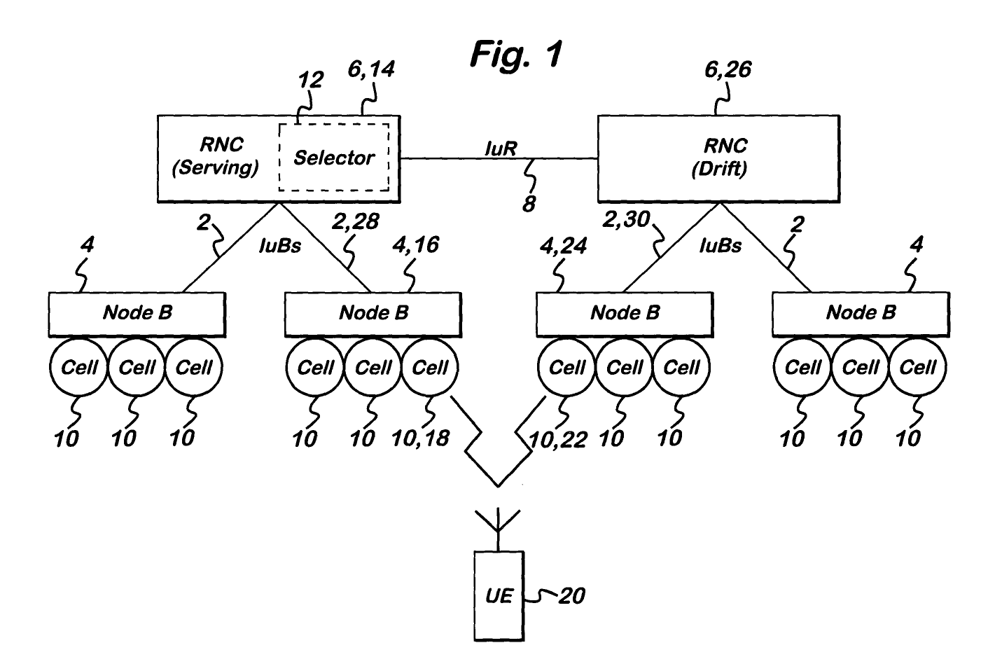

As shown in FIG. 1, there is an interface (denoted IuB interface) 2 between each base station (Node B in UMTS terminology) 4 and radio network controller (RNC) 6, and an interface (known as an IuR interface) 8 between two radio network controllers (RNC) 6. Each base station 4 has one or more cells 10 (i.e. areas of coverage). In UMTS a base station 4 has three cells 10 namely one hundred and twenty degree angular sectors around the base station 4.

As shown in FIG. 1, the selection of which is the best received signal from the various cells in connection with a mobile user terminal 20 during soft-handover is done by a selector 12 which is part of a serving radio network controller 14 controlling a base station 16 having a cell 18 in connection with the mobile user terminal 20. As the mobile user terminal 20 is in a soft-handover phase, signals are also being received by a cell 22 of another base station 24 connected to a drift radio network controller 26.

A frame of data received by the base station 16 connected to the serving radio network controller 14 is sent via the respective IuB interface 28 to the serving radio network controller 14. The same frame of data received by said another base station 24 is sent via IuB interface 30 to the drift radio network controller 26 then to the serving radio network controller 14 from the drift radio network controller 26 via the IuR interface 8 between the two radio network controllers 6,6,14,26. The serving radio network controller 14 then selects the best quality frame arriving within a selected time window (known as the “receive window”) from each of the different cells 10 in the active set (i.e., the set of cells in soft-handover connection, two cells 18,22 of which are shown in FIG. 1 for simplicity. The receive timing window starts running when the first of these frames is received by the serving radio network controller 14. The quality of each frame is determined from the accuracy of receipt of cyclic redundancy check data or bit error rate (BER).

Delay as a Factor in Selection

The selector 12 takes into account factors such as received signal quality and radio resource usage (e.g., channelization code usage, cell loading) when selecting which candidate cell is to be added to the active set, or which currently active cell is to be removed from the active set. The selector 12 in the serving radio network controller 14 additionally takes the total delay due to the interfaces 2,28,30,8 over which a frame received by a candidate cell must be transferred to reach the serving radio network controller into account when making a selection of which candidate cell is to be added to the active set, or which currently active cell is to be removed from the active set. A lower delay is, of course, preferred. The delay caused by an interface is dependent on the loading (i.e. amount of traffic being carried per unit time). Differences in delay in the interface(s) between the Serving radio network controller RNC and a base station are directly related to differences in the traffic load in the interfaces.

These delays are also taken in account in the determination of the monitored set, that is the list of cells to be monitored by the mobile user terminal (UE) for possible selection into the active set.

Take for example, the case where signals from the mobile user terminal 20 are received by two cells 18,22 and the two cells 18,22 are of different base stations (Node B) 16,24. The two different IuB interfaces 28,30 connecting the respective radio network controllers (RNC) 14,26 and base stations (Node Bs) 16,24, each have a different current traffic load and hence produce a differing delay in forwarding the received frame. If the delay is high on one of the IuB interfaces 28,30, the signal from the mobile user terminal 20 via that IuB interface will arrive outside the uplink received time-window (i.e., time —window for reception of signal sent uplink) so not be available for selection by the selector 12.

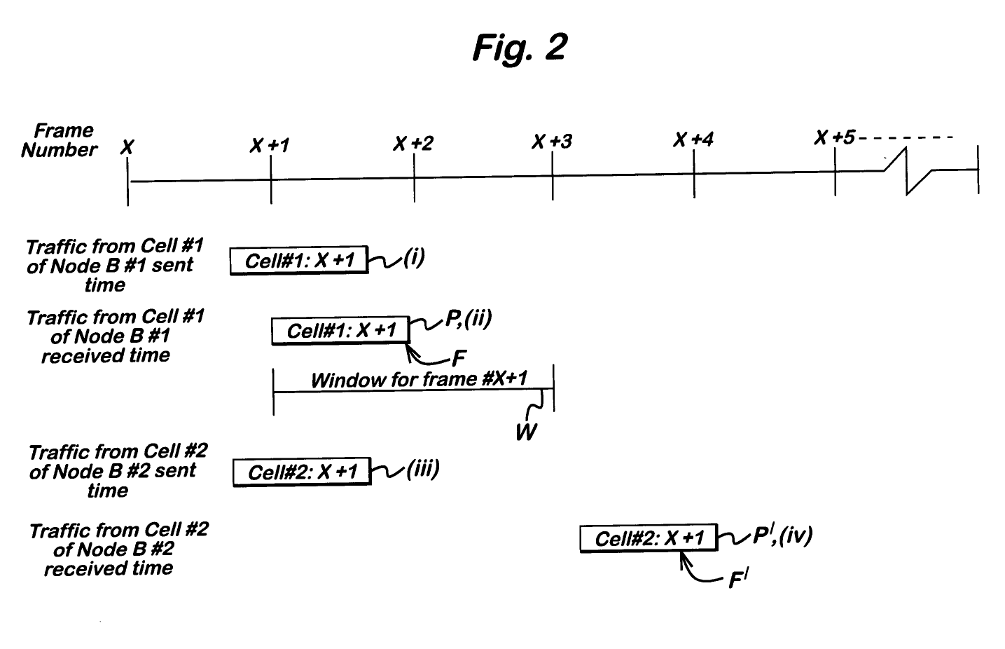

FIG. 2 illustrates an example case of the serving radio network controller RNC 14 and cells 18,22 from two different base stations 16,24. With time being shown in terms of frame number x to x+5 from left to right, the following are shown diagrammatically in FIG. 2:

(i) the time period over which a frame from cell 18 (Cell#1) of base station 16 is sent,

(ii) the time period P over which a frame F from cell 18 Cell#1 of base station 16 is received, (iiii) the time period over which a frame from cell 22 (Cell#2) of base station 22 is sent,

(iv) the time period P′ over which a frame F′ from cell 22 (Cell#2) of base station 22 is received. The receive timing window W is also shown, where window W runs from the start of the time period P over which a frame from cell 18 (Cell#1) of base station 22 is received.

It will be seen that the frame (i.e., traffic block) F′, i.e. the data frame #(x+1). from the mobile user terminal 20 via a cell 22 (Cell#2) will not be selectable (i.e., “contribute to soft handover gain”) within the permitted receive time-window W. Increasing the size of the time-window W would mean that the Serving radio network controller RNC 14 has to buffer frame F (traffic block #(x+1) from the cell 18 (denoted Cell#1)) for longer.

Delay Determination

The delays due to transfer between the two radio network controllers (RNC) 14,26 and between the respective radio network controller (RNC) 14,26 and the base stations 16,24 can be determined using UMTS-standardised uplink/downlink node synchronisation procedures or an uplink/downlink dedicated channel (DCH) synchronisation procedures. Specifically, these delays can be determined using either of the following two procedures over the IuB interface 28, or each of the IuR interface 8 and IuB interface 30, as appropriate. The procedures are based on the same principle, namely sending out a “pinging” signal to a destination node to find out whether the destination node is alive, the destination node sending an appropriate response. The “round trip” time from sending the pinging signal to receiving the associated response is then determined.

One Procedure (DCH Synchronisation)

This procedure is initiated by the serving radio network controller (SRNC) 14 by sending a downlink synchronisation control frame towards a base station 16,24 in soft-handover connection. This control frame indicates a target connection frame number (CFN).

Upon reception of the downlink synchronisation control frame, the base station 16,24 immediately responds with an uplink synchronisation control frame indicating the time of arrival (ToA) for the downlink synchronisation control frame and the connection frame number (CFN) indicated in the received downlink synchronisation control frame. The uplink synchronisation control frame is always be sent as a response, even if the downlink synchronisation control frame is received by the base station within an expected arrival window.

Other Procedure (Node Synchronisation)

This procedure is initiated by the serving radio network controller (SRNC) by sending a downlink node synchronisation control frame containing a parameter T1 to a base station 16,24. Upon reception of a downlink node synchronisation control frame, the base station 16,24 responds with uplink node synchronisation control frame, including parameters T2 and T3, as well as the T1 parameter, which was indicated in the initiating downlink node synchronisation control frame.

The T1, T2, T3 parameters are as follows:

T1 is the radio network controller (RNC) specific frame number (RFN) that indicates the time when the radio network controller (RNC) sends the downlink node synchronisation control frame for transmission, in particular by sending the frame from a service access point (SAP) to the transport layer in accordance with the layered communication protocol defined for UMTS systems.

T2 is a base station specific frame number (BFN) that indicates the time when the base station receives the corresponding downlink node synchronisation control frame through the service access point (SAP) from the transport layer.

T3 is a base station specific frame number (BFN) that indicates the time when the base station sends the uplink node synchronisation control frame through the service access point (SAP) to the transport layer.

While the particular invention has been described with reference to illustrative embodiments, this description is not meant to be construed in a limiting sense. It is understood that although the present invention has been described, various modifications of the illustrative embodiments, as well as additional embodiments of the invention, will be apparent to one of ordinary skill in the art upon reference to this description without departing from the spirit of the invention, as recited in the claims appended hereto. It is therefore contemplated that the appended claims will cover any such modifications or embodiments as fall within the true scope of the invention.

1. A method of selecting cells of base stations of a network for mobile telecommunications for soft-handover connection with a mobile user terminal so as to provide at a first network node multiple received representations of a data frame from the mobile user terminal (20) within a predetermined period,
or each cell delay due to transfer of a representation of the received data frame across interface between network nodes along a transfer path to said first network node is estimated by determining the contribution to the delay caused by each interface along the transfer path,
cells being selected dependent upon the associated delays.

2. A method of selecting cells according to claim 1, for inclusion in an active set of cells in soft-handover connection.

3. A method of selecting cells according to claim 1, for inclusion in a set of cells to be monitored as to radio quality for possible inclusion in an active set of cells in soft-handover connection.

4. A method of selecting cells according to claim 1, wherein cells are selected dependent on factors comprising the delay estimated, the received signal quality and the radio resources available.

5. A method of selecting cells according to claim 1, wherein each cell estimated as providing a representation of the received data frame that arrives at said first network node later than a predetermined time after the first of the representations of the received data frame is not selected.

6. A network for mobile telecommunications comprising a selector operative to select cells of base stations for soft-handover connection with a mobile user terminal so as to provide at a first network node multiple received representations of a data frame from the mobile user terminal within a predetermined period,
and further comprising delay estimation means operative to estimate, for each cell, delay due to transfer of a representation of the received data frame across interface between network nodes along a transfer path to said first network node by determining the contribution to the delay caused by each interface along the transfer path,
the selector being operative to select cells dependent upon the associated delays.

7. A network for mobile telecommunications according to claim 6, wherein the selector is operative to select cells for inclusion in an active set of cells in soft-handover connection.

8. A network for mobile telecommunications according to claim 7, wherein the selector is operative to select cells for inclusion in a set of cells to be monitored as to radio quality for possible inclusion in an active set of cells in soft-handover connection.

9. A network for mobile telecommunications according to claim 6, wherein the selector is operative to select cells dependent on factors comprising the delay estimated, the received signal quality and the radio resources available.

10. A network for mobile telecommunications according to claim 6, wherein the selector is operative such that each cell providing a representation of the received data frame that arrives at said first network node later than a predetermined time after the first of the representations of the received data frame is not selected.
